(19) United States
(12) Patent Application Publication
(10) Pub. No.: US 2012/0074756 A1
(43) Pub. Date: Mar. 29, 2012

(54) LATERAL CUSHIONING TRAVEL PILLOW WITH SELF-SECURING FEATURE

(76) Inventor: Tate Sayre, Carlsbad, CA (US)

(21) Appl. No.: 12/891,808

(22) Filed: Sep. 28, 2010

(51) Int. Cl. A47C 31/00; B60N 2/44

(52) U.S. Cl. 297/463.1

(57) ABSTRACT

A travel pillow or cushioning device that provides lateral comfort in travel or fixed position seating with a one piece, easily installed unit with an inherent self securing design that is positioned on top of an armrest and is further secured between two seat backrests or supported by the interior wall of a moving vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Even the most novice of travelers will become very aware of the inherent desire to be more comfortable while traveling. Fixed in one's seat, immobilized for hours with little relief except the minimal additional comfort from the change of position achieved by pressing the recline button. Many inventors have tried to address this problem, most commonly by the attachment of a cushioning device to ones head or neck with various intended body positions. Not the most flattering of looks for anyone. The only other option, is a request for the standard, previously complimentary, puny excuse for comfort, the airline pillow. This is not much help either. Within very little time this pillow, if you are lucky enough to have the side support of a window seat, slips down to its uselessness or worse becomes the possession of the person behind looking to improve his or her similar predicament. Therein lies the problem. How to provide increased comfort in travel seating, especially laterally where there is little or none available, while at the same time maintaining the position of a device securely enough to furnish comfort for the entire time a user has determined it necessary. Hopefully after a long and peaceful rejuvenating nap.

### PRIOR ART

Previous inventors have proposed numerous devices to the address the need for increased comfort while traveling. Some of the disadvantages and shortcomings of the previous inventions are discussed below.

Henry of U.S. Pat. No. D339021, Sweeney and Lee of U.S. Pat. No. 4,031,578, Corbin of U.S. Pat. No. 6,647,573, Illingworth of U.S. Pat. No. D523679 and Columbo of U.S. Pat. No. 5,800,018 are all variations of wedge shape cushioning devices with little or no ability to be held securely in place. Only U.S. Pat. No. 5,800,018 can be somewhat secured by the use of suction cups and therefore can only be fixed to a smooth surface such as a window and it is often rare on an airplane that one has a window seat located in the exact position to make this possible. Furthermore, none of these allow for side to side comfort in any middle or isle row seating and in no way secure to the armrest and/or to the space between two seat backrests.

Numerous others are either variations of a pillow with an attached bag or others with a neck ring or collar, none of which provide any similar secure lateral cushioning.

### BRIEF SUMMARY OF INVENTION

The invention is a unique cushioning device that provides an extra degree of lateral comfort in fixed positioned seating (i.e. planes, trains, automobiles, movie theaters, etc.) where currently little or none exists while at the same time being held firmly in place with custom design features that allow it to be easily installed and prevent it from slipping away from the user during its use. In addition, because of its shape and its ability to be positioned between two adjacent seats, it can provide a certain amount of privacy between the user and a neighboring passenger which may be an additional desired benefit.

### BRIEF DESCRIPTION OF THE SEVERAL VIEWS OF THE DRAWING

FIG. 1 is a rear view of the invention

FIG. 2 is a bottom view of the invention

FIG. 3 is a side view of the invention

FIG. 4 is a perspective view of the invention

FIG. 5 is a perspective view of the invention installed in seating

### LIST OF REFERENCE NUMBERS

10—radius exterior to match fuselage
11—slot to locate on top of seat armrest
12—trapezoid profile to match reclined seat back rest
13—tab or extrusion to fit securely between seats

### DETAILED DESCRIPTION OF INVENTION

This unique cushioning device is to be a one-piece unit made of undetermined material that will be either of the inflatable type or a semi rigid foam rubber. Lightness and/or collapsibility is an obvious advantage to its convenience and portability.

### 1. Shape

Its intended location somewhat dictates its shape. Its skewed rectangular or trapezoid shape in the side direction (as show in FIGS. 3, 12) lends itself to the position above an armrest and against a non-vertical seat back rest.

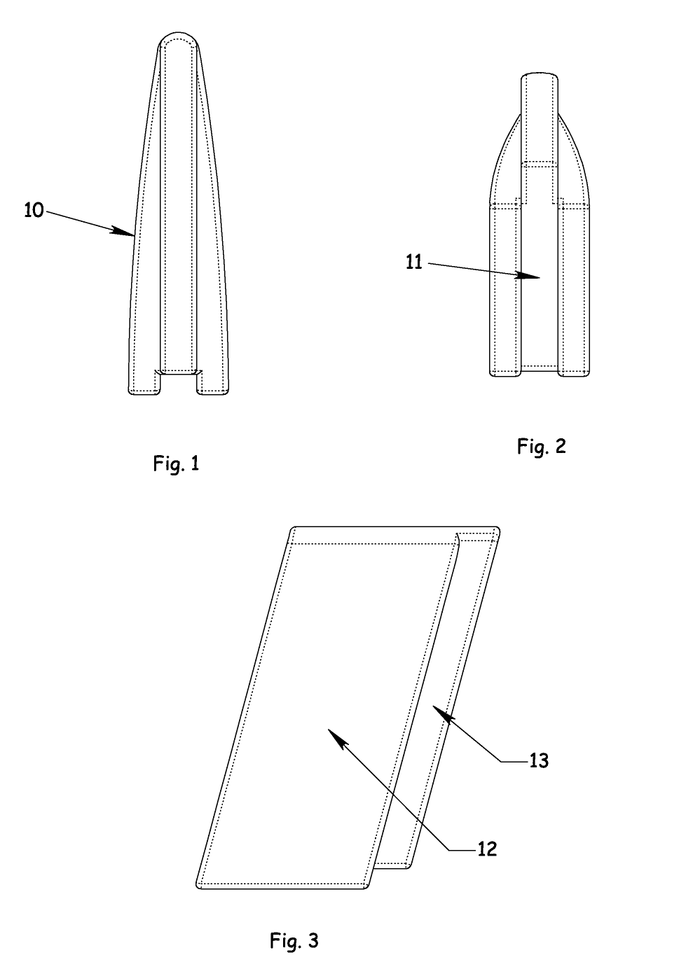

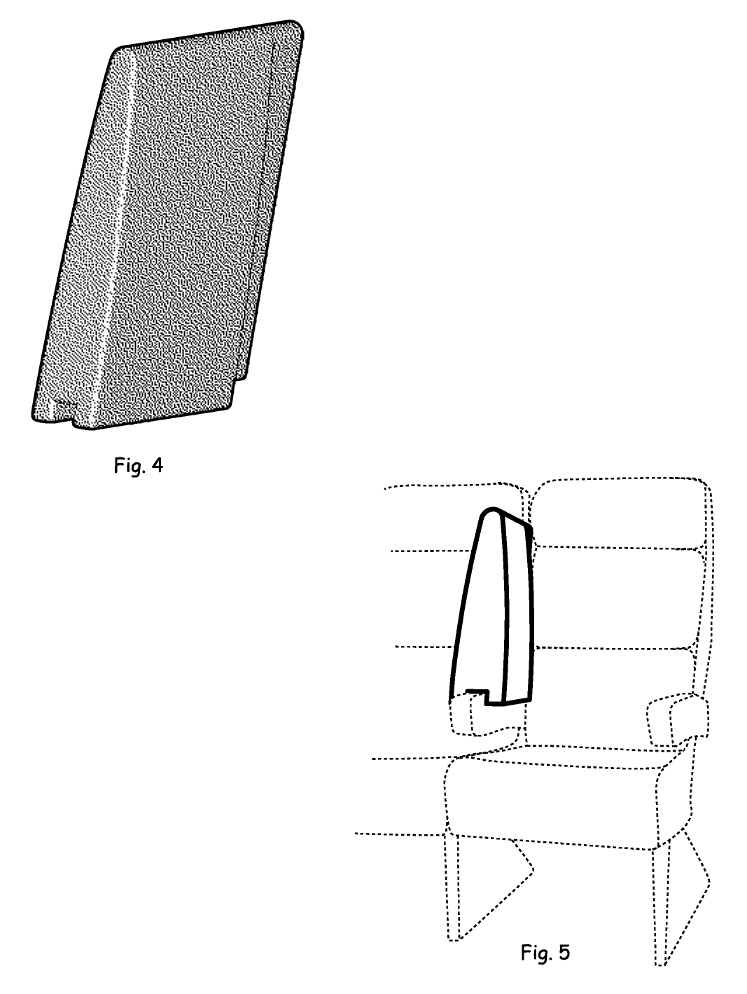

In addition a curved exterior radius (shown in FIGS. 1, 10) is designed to match the inside radius of the fuselage of a passenger plane in order to provide further stability when positioned at a window seat location.

### 2. Self-Securing

The cushioning device will be inherently self-securing and will hold itself in place with two built-in design features. A slot located in the bottom portion (FIGS. 2, 11) will help to position itself on top of a seat's armrest holding it along the “x” axis. A “tab” in the rear portion (FIGS. 3, 13) is to be inserted between two adjacent seat backrests holding it along the “y” axis. The combination of the two securing features, along with its curved radius for use with window seats, will provide a substantial degree of rigidity necessary to hold the device in place for its intended purpose. This has been indicated by tested pre-production prototypes.

The embodiments of the invention in which an exclusive property or privilege is claimed are defined as follows:

1. A cushioning device intended for an individual's personal comfort while located in travel seating or other immovable seating, that provides lateral or side-to-side comfort while by being held securely in place by features specifically designed to attach to an armrest rest, the space between two seat backrests, and/or the support of an interior wall of a moving vehicle comprising.
a) a grove or slot located in the bottom portion of said device allowing for said device to be positioned securely on top of an armrest and provide lateral stability to the bottom portion of said device.
b) a “tab” or extension located in the rear portion of said device specifically designed to be inserted between two adjacent seat backrests and to provide lateral support to the rear portion of said device.
c) a curved side to match similar the interior fuselage for window seat use.

2. A cushioning device intended for an individual's personal comfort while located in travel seating or other immovable seating, that provides lateral or side-to-side comfort while by being held securely in place by features specifically designed to attach to an armrest rest, a seat backrest, and/or the support of an interior wall of a moving vehicle comprising.
a) an armrest attachment means for attaching to an armrest rest.
b) a seat back attachment means for attaching to a seat back rest.
c) a curved side to match similar the interior fuselage for window seat use.
